(19) United States
(12) Patent Application Publication
(10) Pub. No.: US 2006/0173792 A1
(43) Pub. Date: Aug. 3, 2006

(54) System and method for verifying the age and identity of individuals and limiting their access to appropriate material

(76) Inventor: Paul H. Glass, Laguna Beach, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/118,667

(22) Filed: Apr. 28, 2005

Related U.S. Application Data
(63) Continuation-in-part of application No. 11/036,234, filed on Jan. 13, 2005.

(51) Int. Cl. G06Q 99/00; H04L 9/00; H04K 1/00

(52) U.S. Cl. 705/75

(57) ABSTRACT

Limiting access to the Internet, eCommerce websites, accounts and/or other venues, for example, by providing an Internet access account, and/or other access account, to an “in person” and/or “single number” age verified and identified “adult” who assumes responsibility for use of such account and viewing of appropriate material via such account by “in person” age verified and identified individuals, while being empowered by control of a “single access account” that filters inappropriate material based on (1) user profiles created by age verified and identified adults and stored on provider's “access server” and/or (2) “mandatory” provider imposed filtering.

### RELATED APPLICATION

This application is a continuation-in-part of U.S. application Ser. No. 11/036,234 filed Jan. 13, 2005.

### BACKGROUND OF THE INVENTION

Despite a strong desire to shield minors from accessing harmful material on the World Wide Web, a consensus exists that the battle is being lost in the United States. An adult entertainment industry spokesperson has commented that the adult industry does not want minors to visit adult web sites. That said, the adult industry believes it is the responsibility of parents to monitor and prevent their children from accessing and viewing harmful material, such as adult web sites and other web sites containing inappropriate material for minors. Most parents and the United States government believe that a prohibition on the distribution to minors of harmful material is necessary. This belief necessitates an effective system and method to effectively implement such a prohibition.

To date, a significant amount of the responsibility for preventing children from accessing offensive material on the Internet has been left to parents, whom society expects to take an active interest in their children's activities. Parents can filter or block offensive material, and if necessary, eliminate Internet access in their home.

The Child Online Protection Act (“COPA”), passed by Congress in October 1998, mandated the COPA Commission, a congressionally appointed panel. The primary purpose of the Commission was to identify technological or other methods that would help reduce access by minors to material that is harmful to minors on the Internet. Congress found that widespread availability of the Internet continues to present opportunities for minors to access materials through the World Wide Web in a manner that can frustrate parental supervision or control. Congress noted that the computer and Internet industries have developed innovative ways to help parents and educators restrict material that is harmful to minors through parental control protections and self-regulation. Congress further pointed out that such efforts have not provided a national solution to the problem of minors accessing harmful material on the World Wide Web.

### SUMMARY OF THE PREFERRED EMBODIMENTS

The present invention overcomes the deficiencies of prior schemes for preventing minors from accessing harmful material on the World Wide Web by providing a system and method of age and identity verification at the point of creation of an Internet access account. The invention permits only adult applicants (“users”) to obtain unrestricted Internet access accounts and/or other access accounts upon “in person” adult verification of their age and identity, and by requiring those age-verified adults to assume responsibility for the use of such accounts by minors and others. The “in person” adult verification method disclosed in the instant application relies on the most reliable means of establishing personal identity, namely personal recognition.

The “single number” verification system disclosed in the instant application may be used for the secure, encrypted transmission of a user's social security number, credit card number or other unique personal identification number. This “single number” approach does not require the disclosure of any transmitted critical personal identification number, including, without limitation, a user's social security number, credit card number, driver's license number or any other unique identification number. Where further verification of the user's age and identity is needed the user submits (1) his or her name, (2) a “single number” that the user computes by applying a provided mathematical formula to his or her social security number (or other unique personal identification number) and (3) one or more additional piece(s) of information, such as address, birth date, etc. The verifying body then applies the same mathematical formula to the user's social security number that it retrieves from an accessible secured database, such as a credit reporting bureau. If the “single number” matches the number calculated by the verifying body, the corresponding age data in the database record is reviewed in order to verify the user's age of majority status. Since a substantial percentage of adults never disclose or are uncomfortable disclosing their social security number as a precaution to prevent identity theft, the “single number” method is attractive to a large segment of the population. This “single number” method may be implemented using any other type of unique, independently verifiable personal identification number contained in an accessible database.

Verified adults who are parents or legal guardians of a minor child may also have the child's age and identity verified using the “in person” and “single number” identity verification methods. Once a minor child's age and identity are verified such minor is granted use of his or her parent's access account. The adult parent is also empowered to restrict such minor's interaction to online content and interactions deemed age-appropriate by the parent/guardian, including age-restricted (e.g. “children only” Internet chat rooms, forums and the like).

The adult parent's access account is a “single access account” that provides shared access to one or more registered user profiles of adults, minors and others that have had their age and identity verified, before being associated with a particular “single access account.” The user profiles are created by the age verified and authenticated adult that obtains a “single access account.” When such adult creates the user profiles, the content categories to be filtered for each user profile associated with the account are selected by such adult. In addition, white listing websites and black listing websites can be adopted when the user profile is created. Such listings would be a combination of one or more commercially available listings and/or a custom listing developed by such adult. White listed websites are those deemed to be acceptable for viewing, whereas, black listed websites are those deemed inappropriate for viewing. This filtering is in addition to any categories required by the Internet access provider to be filtered. For example, the Internet access provider may impose mandatory filtering based on one or more specific filtering categories and/or listings, such as the pornography category and/or listed pornography websites, always remaining turned on with respect to all registered user profiles belonging to minors, thus blocking pornography from being viewed by any minor that has access via such “single access account” or an eCommerce website. An eCommerce website that wants to limit exposure of its content to age appropriate individuals can adopt the “in person” adult verification method disclosed in the instant application, much like the provider of the “single access account” (an ISP) adopts such verification method.

### BRIEF DESCRIPTION OF THE DRAWINGS

A detailed description of embodiments of the invention is illustrated by way of example, and not by way of limitation, in the figures of the accompanying drawings, wherein like numerals designate corresponding parts in the several drawings.

FIG. 1 is a flowchart depicting a system for restricting an access account to adults via an “in person” adult verification system, according to a preferred embodiment of the present invention.

FIG. 2 is a flowchart depicting steps involved in verifying age and identity of an individual through a “single number” verification system, according to a preferred embodiment of the present invention.

FIG. 3 is a flowchart depicting the “in person” verification system that is used to verify the age and identity of a minor or an adult, other than the adult owner of an access account, according to an alternative embodiment of the present invention.

FIG. 4 is a flowchart depicting a system for creating a “single access account,” according to another preferred embodiment of the present invention.

FIG. 5 is a flowchart depicting steps involved in the use of a “single access account” with a dual layer of network authentication, according to a preferred embodiment of the present invention.

FIG. 6 is a diagram depicting example data used in the Age-ID and Profile-ID databases, according to a preferred embodiment of the present invention.

FIG. 7 is a diagram depicting a system in which multiple user profiles sharing a “single access account” have varied levels of filtered Internet access based upon verified age and identity, according to a preferred embodiment of the present invention.

FIG. 8 is a diagram depicting a system for verifying the age and identity of an individual for the purpose of allowing only verified age appropriate individuals to make adult purchases online based on the individual's profile, according to a preferred embodiment of the present invention.

### DETAILED DESCRIPTION OF THE PREFERRED EMBODIMENTS

Following is a description of the best mode for implementing the present invention including a system and method for authenticating individuals' identities comprising a primary “in person” component and secondary “single number” component for the purpose of providing adults unfiltered Internet access and minors filtered Internet access via a “single access account.”

The “In Person” Component

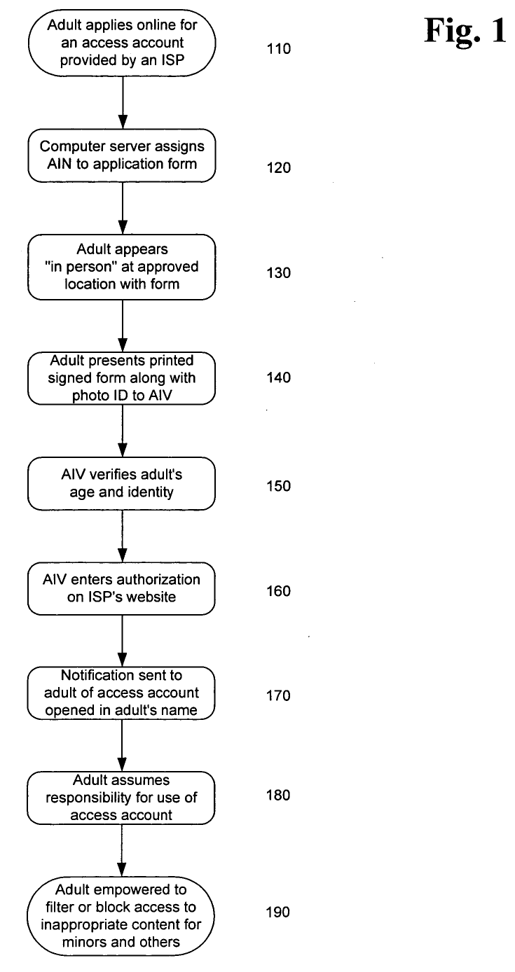

FIG. 1 depicts the steps involved in verifying an individual's age and identity using an “in person” verification system for the purpose of limiting Internet access account registration to adults. As shown in Step 110, a user fills out an online application form to open an Internet access account with an Internet access provider (“ISP”). Upon completing the on-line form, the ISP's computer server assigns an Application Identification Number (“AIN”), as illustrated in Step 120. The AIN is not assigned until all of the required portions of the online form are completed. The user then prints a copy of the form containing the AIN and takes the form to an Authorized Identity Verifier (“AIV”) for completion of the “in person” adult verification in the application, as illustrated in step 130. Specifically, the user will be required to appear “in person” preferably within a predetermined time frame at an approved location for verification purposes. Examples of such approved locations could include, without limitation, factories, offices, schools, libraries, retail businesses, organizations and/or agencies. As shown in step 140, the user presents the printed and signed “in person” adult verification form, along with a piece of photo identification showing the user's age, to the AIV at the approved location. For example, the AIV could include a librarian or secretary, or someone familiar to that location's “community,” such as a factory payroll administrator, etc. As depicted in step 150, the AIV verifies the age and identity of the user based on the identification presented and, as shown in step 160, logs on to the ISP's web site using a secure password provided by the ISP to approved AIV's, and keys in an authorization code in the AIN record in the ISP's access account application system, thus completing the application and approval process to open an Internet access account with the ISP.

The age and identity verification system described herein is a dependable method to ensure that Internet access accounts and/or other access accounts are only sold to adults. Entirely technology-based adult verification systems, which are by their nature unable to verify the true identity of the user keying in the data (although they may verify the accuracy of the data itself) are not as reliable as having an AIV personally accept an Internet access account application form, observe the user's personally presented identification credentials, and, if necessary, utilize further confirmation methods as a precursor to granting unrestricted access.

Once the AIV submits verification to the ISP that the user is of the age of majority, the user may proceed to purchase an Internet access account that provides adult individual access to all Internet content. The user is notified of the new Internet access account by the ISP, as shown in step 170. New account information and the ISP's rules and procedures are also provided at that time.

Upon purchasing the account, the age verified user assumes responsibility, as the access account holder, for protecting minor children and other users of the account, as illustrated in step 180. The adult is thus empowered to filter or block access to inappropriate content for minors and inappropriate individuals, as shown in step 190.

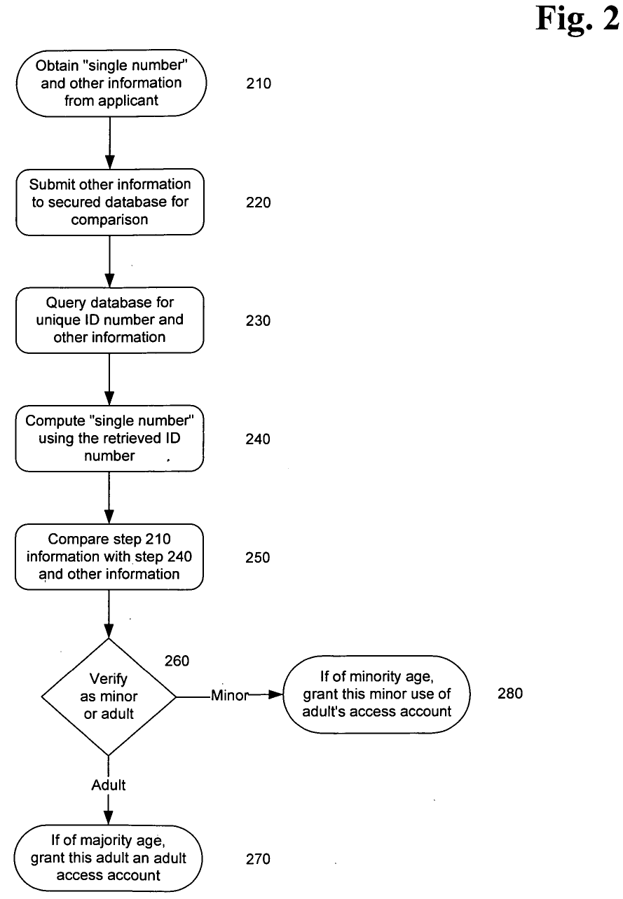

The “in person” adult verification method requires verification of user identity off-line. A very high confidence level relative to accurate authentication is achieved by using the off-line approach. ISP's may additionally verify service applicants' age and identity by using the on-line “single number” verification method described more fully below and in FIG. 2 to enhance the level of confidence. To further enhance the very high confidence level relative to accurate authentication using the “in person” and/or “single number” approach, there are additional methods by which a human can authenticate themselves that fall into the following three categories:
Something the user is [e.g., fingerprint or retinal pattern, DNA sequence (there are assorted definitions of what is sufficient), voice pattern (again several definitions), signature recognition or other biometric identifier]
Something the user has (e.g., ID card, security token or cell phone)
Something the user knows [(e.g., a password, a pass phrase or a personal identification number (PIN)]

The “in person” method may be most effectively implemented in situations where community organizations like churches, schools or the like, partner with an ISP in order to sell Internet access accounts as a fundraising tool. For example, the AIV could be a teacher, school administrator or secretary that is available on the premises at the time most parents are nearby, e.g. pick-up and drop-off times of day. This method would also work in geographic areas dominated by a single or small number of large employers, where the AIV would be a staff member, foreperson or administrator, such as a payroll clerk on the employers' premises.

The “Single Number” Component

FIG. 2 depicts a method of confirming a user's age and identity using a global computer network. First, as shown in step 210, a “single number” that a user computes by applying an ISP-provided mathematical formula to the user's social security number or credit card number, for example, is submitted to the ISP via a global computer network interface with the user's name and at least one additional piece of personal non-private information, such as a home address, credit card billing address, date of birth, etc. The following table provides an example of one possible formula that could be used to compute the “single number”. The formula in Table 1 was chosen merely as an example and is not intended to be the sole claimed embodiment of the “single number” component claimed herein. For example, other numbers could include passport, driver's license or credit card. In addition, another number could be developed using another possible formula that could be used to compute the “single number” based on another number and/or combination of numbers that are available from a secured database, such as, for example, a credit bureau. One, or more, of a combination of numbers could be included in the formula that produces a “single number” upon their placement into the formula at transmittal that is confirmed upon retrieval of such numbers from the secured database, such as, for example, social security number, passport number, driver's license number, credit card number, date of birth, zip code and/or others. In addition, one or more letters, such as, for example, person's initials, mother's maiden name, abbreviation of state of birth and/or others, accessible from a secured database, such as, for example, a credit bureau, could be thrown into the mix to create a “single number” that could include letters, much like a CA driver's license number (an identifying number), includes a letter.

TABLE 1
Computation of “Single Number”

Sample Social Security Number:
First Computation to Arrive at the “Single Number”:
Add together the nine digits of the social security number
6 + 6 + 5 + 6 + 7 + 4 + 3 + 3 + 2 = 42
Second Computation to Arrive at the “Single Number”:
Multiply the sum from the first computation by the social security Number
42 × 665,674,332 = 27,958,321,944
The “Single Number” for Social Security Number Verification:
27,958,321,944

Next, as shown in Step 220, the ISP submits the user name and additional piece of personal information to one or more available secured database(s), such as a credit reporting database, governmental database, such as that of the state Department of Motor Vehicles, or the like, which information is used to identify the correct individual's database record. In Step 230, the database is queried for the applicable identification number in the database record, such as the Social Security number. As illustrated in step 240, the same mathematical formula is applied to the retrieved number by the ISP's query engine. The independently computed “single number” arising from the retrieved social security number is then compared for agreement to the individual's submitted “single number,” as shown in step 250. If the resulting number matches the “single number” submitted by the user, the ISP next queries the database for the user's date of birth, as shown in step 260, in order to determine whether the user is of majority age and therefore qualified to obtain an age-restricted “unfiltered” account, as shown in step 270. If the user's age is found to be that of a minor, the ISP may deny access and request that the minor have his parent or legal guardian open a subsidiary account for the minor under the adult user's account, as shown in step 280. The “single number” method may be used for other applications that currently involve disclosure of sensitive private personal identification numbers, including for example, transmission of one's social security number, credit card number, bank account number, driver's license or other identification number, and/or any other confidential number for any purpose over a computer system or network.

It should be appreciated that the “in person” component and “single number” component disclosed herein may operate independently or in conjunction with one another, although preferably, they operate most effectively when the “single number” and “in person” components are combined.

It should further be appreciated that the use of the foregoing formula can be used in a way whereby the formula is provided to the prospective access account applicant in the form of a distributed CD or on a website for computational use. The applicant could then apply the formula and transmit the result to the appropriate party. The CD could be of the type that ISPs, such as AOL, distribute at the consumer and retail level to promote customer sign-up.

Minor Verification System

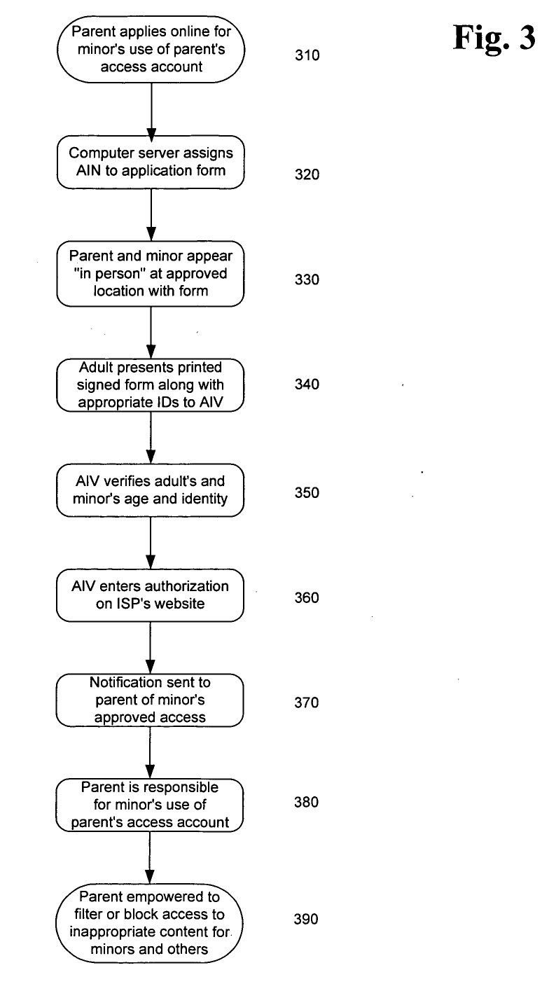

Similar to FIG. 1's depiction of the adult “in person” component, FIG. 3 depicts a method of verifying the age and identity of a minor using a “minor verification” system, and then limiting such minor's interaction to age appropriate content and individuals, such as interacting in an Internet chat room with other minors only and no adults. Similar to the “in person” adult verification method, there are three phases to minor verification, namely: application, authentication, and access. As shown in Step 310, a parent or legal guardian (an adult) fills out an online application form for a minor's use of such parent's Internet access account with an Internet access provider (“ISP”). Upon completing the on-line form, the ISP's computer server assigns an Application Identification Number (“AIN”), as illustrated in Step 320. The AIN is not assigned until all of the required portions of the online form are completed. The parent then prints a copy of the form containing the AIN and takes the form to an Authorized Identity Verifier (“AIV”) for completion of the “in person” minor verification in the application, as illustrated in step 330. Specifically, the parent and minor will be required to appear “in person” preferably within a predetermined time frame at an approved location for verification purposes. Examples of such approved locations could include, but not be limited to, factories, offices, schools, libraries, retail businesses, organizations and/or agencies. As shown in step 340, the parent presents the printed and signed “in person” minor verification form, along with parent's photo identification and appropriate minor identification, to the AIV at the approved location. For example, the AIV could include a librarian or secretary, or someone familiar to that location's “community,” such as a school administrator, etc. As depicted in step 350, the AIV verifies the age and identity of the minor based on the identification presented and, as shown in step 360, logs on to the ISP's web site using a secure password provided by the ISP to approved AIV's, and keys in an authorization code in the AIN record in the ISP's access account application system, thus completing the application and approval process for a minor's use of a parent's Internet access account with an ISP. The parent then receives notification of “minor verification” for account access use, as depicted in step 370. Account access use information and procedures relative to minors are also provided at that time. The age verified parent's purchased access account may now be used by this verified minor.

When the age verified adult/parent purchased the access account, the age verified adult/parent assumed responsibility, as illustrated in step 380, (as the Internet access account holder) for protecting minor children and other account users. That is, upon purchasing the Internet access account, the age verified adult/parent received control of (1) adult access (the entire Internet universe) for appropriate individuals and (2) family access (a filtered Internet universe) for minor children and others. This method promotes family access in a variety of ways, such as limiting a minor's interaction to age appropriate content and individuals, such as interacting in an Internet chat room with other minors only and no adults. Indeed, much has been written about dangers on the Internet, but if a child is going to get in trouble online, chances are that it will be because of something that happens in a chat room. While millions of children engage in chat and instant messaging every day and the overwhelming majority is not victimized, a number of the leads reported to the National Center for Missing and Exploited Children's (NCMEC) CyberTipLine are “online enticement” cases where the vast majority started out in a chat room. The adult is thus empowered to filter or block access to inappropriate content for minors and inappropriate individuals, as shown in step 390.

Again, the “minor verification” method requires verification of minor identity off-line, and may, in addition, use the on-line “single number” verification method as well as other methods for further confirmation of age and identity. A very high confidence level relative to accurate authentication is achieved by always using the off-line approach, and sometimes, in addition, using the on-line approach to enhance the level of confidence. Other surrogate methods that may be used for verification purposes include, but are not limited to, signature comparison, passwords (numbers, letters and/or words provided in a particular order or otherwise), a personal identifying number known only to the individual (PIN), encryption for authentication, digital or digitized signatures, identity documents with photographs, fingerprint comparison (where there is no stigma or compulsion), and forms of biometrics.

The “Single Access Account”

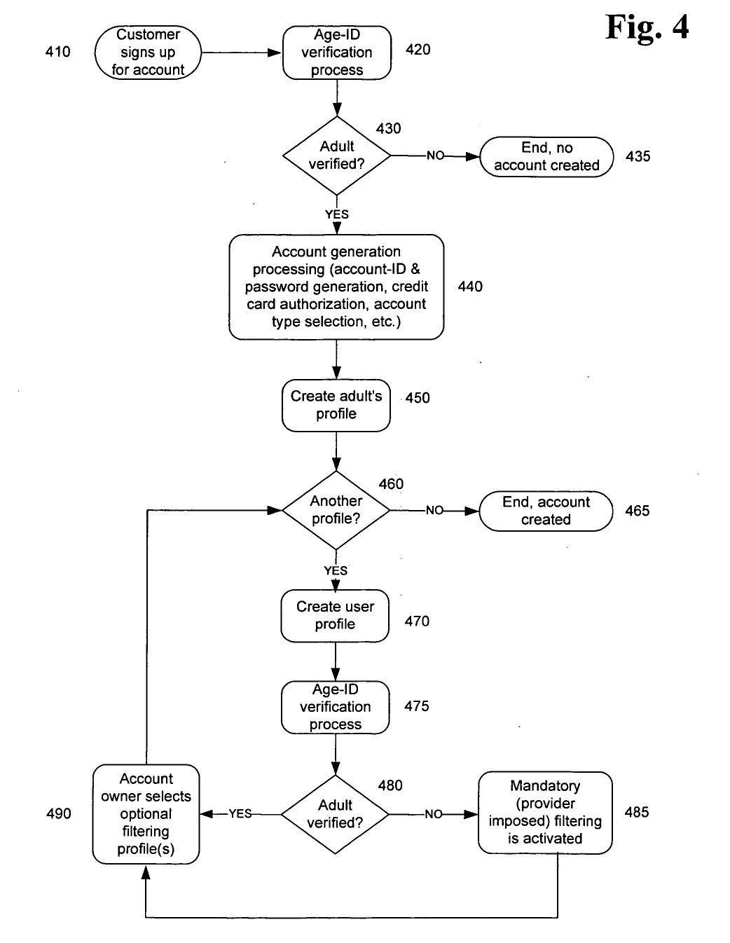

FIG. 4 depicts a system of creating a “single access account.” First, as shown in step 410, a prospective user signs up, via an ISP, for an access account that will be used by an age verified and authenticated adult and possibly one or more age verified and authenticated minors and others. Next, as shown in step 420, this prospective user goes through the process of having his or her age and identity verified by being subject to the “in person” verification system (as illustrated in FIG. 1) and/or “single number” verification system (as illustrated in FIG. 2). As shown in step 430, the prospective owner of the “single access account” is verified as being either an adult or a minor. As shown in step 435, if the prospective owner of the “single access account” is not verified as being an adult, the sign up process ends without a “single access account” being created.

In the alternative, as shown in step 440, if the prospective owner of the “single access account” is verified as being an adult, the sign up process continues with a “single access account” being created. Upon the creation of the “single access account,” an account-ID and password are generated, a credit card is authorized, and the account type is selected.

As shown in step 450, a filtering profile is selected for the owner of the “single access account.” For example, as an adult owner of the “single access account,” such adult can select complete unfiltered access to all Internet content and features provided by the ISP. Another option for such adult is to request filtering of certain unwanted Internet content and features, as determined solely by the adult owner of the “single access account,” and no other individual or entity. Next, as shown in step 460, the adult owner of the “single access account,” can elect to create additional user profiles for minors and other individuals, at sign up time or later if desired.

As shown in step 465, once no additional user profiles are created at sign up time, the sign up process ends with a “single access account” being created for use by those individuals who are registered with user profiles associated with this account. Filtering is immediately activated upon the creation of this new “single access account” and such filtering is always turned on, and cannot be turned off by the adult owner of the “single access account” or any other additional user of the “single access account,” unless permitted by the ISP to do so. For example, the ISP may require that one or more specific filtering categories, such as “pornography,” always remain turned on with respect to all registered user profiles belonging to minors, thus blocking minors from viewing “pornography.”

If at step 460 the adult owner of the “single access account” has elect to create additional user profiles for minors and/or other individuals that will use the “single access account,” these profiles are then created, as shown in step 470. As stated above, this can be done when the “single access account” is first opened, or at any subsequent time. Next, as shown in step 475, any prospective additional user goes through the process of having his or her age and identity verified by being subject to the “in person” verification system (as illustrated in FIG. 3) and/or “single number” verification system (as illustrated in FIG. 2). As shown in step 480, the prospective additional user is verified as being either a minor or an adult. As shown in step 485, if the prospective additional user is a minor, mandatory (ISP imposed) filtering is activated for such minor's user profile. For example, mandatory (ISP imposed) filtering may be implemented to block “pornography.” Next, as shown in step 490, the owner of the “single access account” selects additional optional filtering to be associated with such minor's user profile. If the prospective additional user is an adult, the owner of the “single access account” selects optional filtering to be associated with the prospective additional adult's user profile.

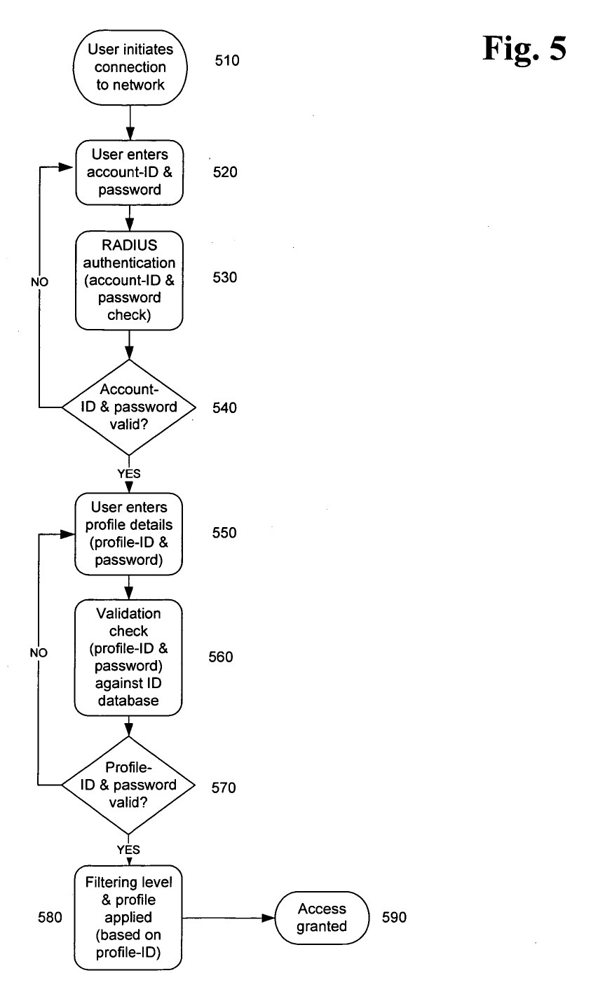

FIG. 5 depicts a method of accessing a “single access account.” First, as shown in step 510, a user initiates connection to the ISP's computer server using their “single access account.” This initial step is the beginning of the first layer of dual layer authentication for the use of the “single access account.” Next, as shown in step 520, the user enters their account-ID and password. As shown in step 530, the ISP authenticates the entered account-ID and password (using RADIUS, Remote Authentication Dial In User Service, or the like). As shown in step 540, based on the determination as to whether the account-ID and password are valid or not valid, the user either starts the authentication process over (by returning to step 520) or moves on to the second layer of dual layer authentication.

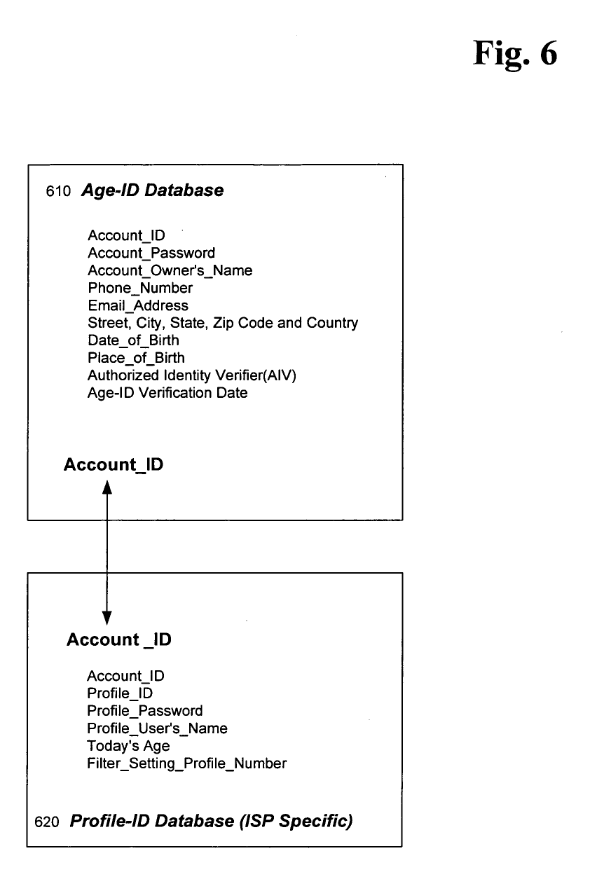

Next, as shown in step 550, the user enters such user's profile-ID and password. As shown in step 560, the entered profile-ID and password are authenticated as being from amongst the multiple registered user profiles maintained in the “age-ID database” (as illustrated in FIG. 6) and associated with the “single access account” being logged into. As shown in step 570, based on the determination as to whether the profile-ID and password are valid, or not valid, the user either re-enters the profile-ID again (by returning to step 550), thus starting the second layer of dual layer authentication over, or as shown in step 580, the filtering level of that user's profile is applied, thus defining the user's applicable level of access based on such user's individual profile that is on record in the stored profile-ID database. Next, as shown in step 590, the user begins such user's authenticated and filtered access. After completion of the dual layer authentication, and the user being granted access, content is made accessible based on the user's profile, as illustrated in FIG. 6.

At this point, when to age verified and authenticated user's log on, the access provider transmits appropriate levels of filtered content via the “single access account” based on (1) user profiles created by the “adult” account holder and stored on the access provider's “access server” and/or (2) “mandatory” access provider imposed filtering. Adults always receive unfiltered content, unless they decide otherwise and turn on the filtering of selected categories within their user profile.

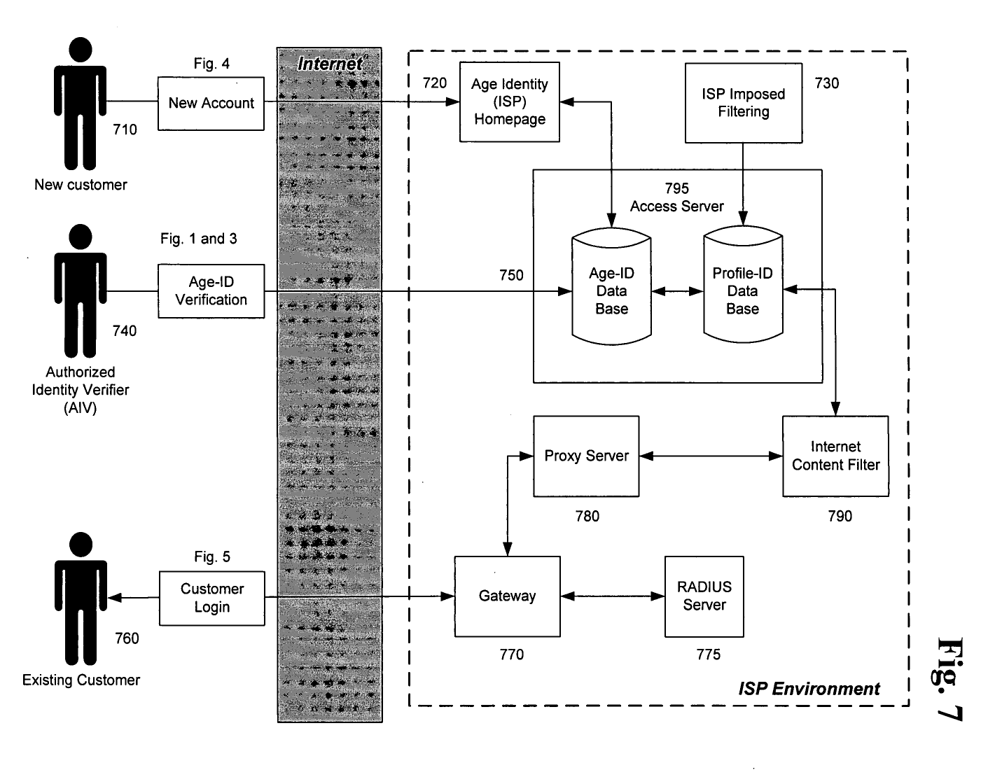

FIG. 6 depicts two aspects of the ISP environment that are shown in FIG. 7. Shown in 610 is the age-ID database and in 620 is the profile-ID database that is ISP specific in that such database would vary from ISP to ISP. For example, the age-ID database 610 can include, but is not limited to, “account id,” “account password,” “account owner's name,” “phone number,” “e-mail address,” “address information,” “date of birth,” “place of birth,” “authorized identity verifier (AIV),” and “age-id verification date.” This information is specific for each user on the account. Accordingly, for each account there may be one or multiple entries in the age-id database 610. The profile-ID database 620 can include, but is not limited to, “account ID,” “profile ID,” “profile password,” “profile user's name,” “today's age,” and “filter setting profile number.” It should be understood, that the items listed/displayed in each of these two databases are only an example of what data may be collected within each of these electronic databases and are not intended to be a limitation on the present invention. The “age-ID” database information and the profile-ID database information may be stored on an access provider's access server or any other server where such database information files may reside and be electronically accessible.

FIG. 7 shows an example of the overall system and method for creating a new “single access account” and using such account. As shown in step 710, a new “single access account” is created, as illustrated in FIG. 4. Step 720 represents the process shown in FIG. 1, where the new customer initially went online to begin the account registration process by completing the online registration form that was then printed and brought to an “in person” approved location. Upon initially entering the registration information, it was captured and saved in the ISP's “age-ID” database 610 (as shown in FIG. 6) that resides on the ISP's access server. Certain of this information is also saved in the profile-ID database 620 (as shown in FIG. 6) on the ISP's access server and the database on the access server where ISP imposed filtering directives are entered by the ISP, as shown in step 730. This ISP imposed filtering can enable the elimination of certain select Internet content across the board, such as, for example, precluding the viewing of pornography by minors.

As shown in 740, when an adult applies for a “single access account,” as illustrated in FIG. 1, and/or an adult applies for others use of such adult's “single access account,” as illustrated in FIG. 3, age and identity are verified by an AIV who submits via the Internet, as shown in step 750, confirmation of the age and identity of these individuals who will be using such adult's “single access account.” As shown in step 760, when “single access account” users access the Internet using the “single access account,” as illustrated in FIG. 5, they login entering the ISP environment via the ISP's provided gateway, as shown in step 770. As shown in step 775, RADIUS (Remote Authentication Dial In User Service) authentication (a valid account-ID and password) occurs. If the RADIUS authentication is successful, next, as shown in step 780, proxy enabled filtering occurs. Next, as shown in step 790, the user profile and appropriate filtering level is determined and applied, based on the profile-ID database 620 residing on the access server 795, as Internet access is granted.

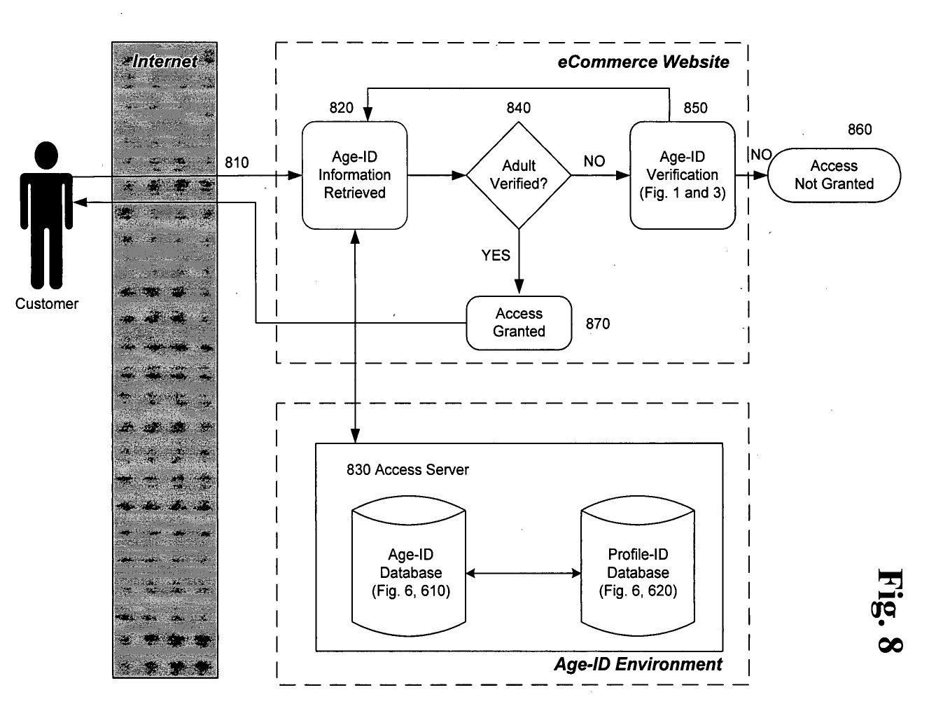

FIG. 8 shows an example of how an eCommerce website can utilize the “age-ID” verification process to identify adults, minors and/or other individuals. In step 810 a customer attempts to access an eCommerce website that utilizes the “age-ID” verification process. For this illustration, it is assumed this eCommerce website only wants to admit adults to its website. It will be understood that this is only exemplary and that the “age-ID” verification process can be used in a manor that establishes any minimum and/or maximum age, with/or without applying other selected requirements in addition to age, such as race, religion, sexual orientation or any other personal information. Also, the age and identity of an individual can be verified online for the purpose of allowing a verified age appropriate individual to participate in activities, such as, purchasing items, selling items, accessing information, transmitting information, viewing content, posting content, pushing content, broadcasting programs, instant messaging, entering a chat room, performing live and otherwise interacting online via an eCommerce website or any type website based on the user's profile. Furthermore, the age and identity of an individual can be verified online for the purpose of granting a verified age appropriate individual access to an online or offline environment. First, as shown in step 820, “age-ID” information is retrieved from the access server located at step 830. Based on the retrieved information, a conclusion is reached, as shown in step 840, as to whether the customer attempting to access this eCommerce website is a verified adult. As shown in step 850, if the answer is “no,” then the customer is required to go through the “age-ID” verification process (in a manor similar to that illustrated in FIG. 1 for adults, or in a manor similar to that illustrated in FIG. 3 for minors and other individuals) and establish an “age-ID” account, before being permitted to access the site. As shown in step 860, if the customer is not verified as an adult, access is not granted. In the alternative, as shown in step 870, if the customer is verified as an adult, access is granted.

Implementation and Application

The systems and methods disclosed herein are preferably implemented by suitable computer systems, data based and through the Internet. An appropriate central processing unit (“CPU”) and database for the “in person” and “single number” verification methods can be used to implement and track the “in person” verification process, to facilitate performance of the “single number” verification method, to implement and maintain the “single access account” system using the “age-ID” and profile-ID databases, and to limit access to websites and other places, such as locations, environments and venues, whether found online or offline.

While the above description refers to particular embodiments of the present invention, it will be understood to those of ordinary skill in the art that modifications may be made without departing from the spirit thereof. The accompanying claims are intended to cover any such modifications as would fall within the true scope and spirit of the present invention.

The presently disclosed embodiments are therefore to be considered in all respects as illustrative and not restrictive; the scope of the invention being indicated by the appended claims, rather than the foregoing description. All changes that come within the meaning and range of equivalency of the claims are therefore intended to be embraced therein.

For example, the “in person” and/or “single number” identity verification methods can be used by businesses for a variety of purposes beyond providing and/or selling an access account to a verified individual. Additional uses of the invention include, without limitation: (1) enabling businesses to confirm via the Internet the age and identity of an individual for purposes of permitting such individual to view, handle, obtain and/or buy adult products, services and/or entertainment at any one of a variety of places, such as an adult business, an Internet website, a mail order company, a manufacturing facility and/or a distribution center, (2) facilitating interaction amongst verified minors in a variety of venues available on the Internet, and elsewhere, while precluding adults from posing as minors to interact with actual minors, and (3) providing for the benefit of an Internet service provider (“ISP”), its customers and other third parties a valuable ISP database arising from Internet collected information and the computerized retention, sorting and distribution of such information with respect to verified adults and/or their minors, including, without limitation, verified adults and/or their minors obtaining/printing discount certificates off the Internet via their computers for a variety of purposes, such as using an adult's discount certificate at an adult business and/or using a child's discount certificate at a children's theme park.

The systems and methods disclosed herein apply to all variations of current, evolving, and future technology and processes that could otherwise adopt and use these systems and methods to achieve similar results. For example, these claimed systems and methods could otherwise be adopted and used in the television broadcast environment, radio broadcast environment, computer intranet environment, computer hard drive environment, wireless internet, cellular environment, distance learning environment and elsewhere. They could also otherwise be adopted and used in any environment that enables individuals to share and/or access information, files, data, music, movies, pictures, conversation, plots, games, etc. by electronic or other means.

What is claimed is:

1. A method of verifying the age and identity of an individual using a system to limit the provision of an access account to an “in person” age verified and identified adult, the steps comprising:
applying online by the individual for an adult access account;
completing and signing an adult verification form;
appearing in person at one of a plurality of approved locations;
submitting in person completed and signed adult verification form;
validating information in the adult verification form, in the presence of the individual;
validating the individual's age and identity, in the presence of the individual;
notifying the individual of newly opened adult access account in the individual's name;
requiring an age verified and identified adult to assume responsibility for use of the adult access account by minors and others; and
empowering the individual to filter or block access to inappropriate content and entities.

2. The method of claim 1, wherein the adult access account is an Internet account or other access account.

3. The method of claim 1, wherein the one of a plurality of approved locations include authorized industries, schools, businesses, organizations, and agencies.

4. The method of claim 1, wherein adult purchasers gain access to the adult access account with a password to a non-filtered environment.

5. The method of claim 4, wherein minors for whom the adult purchasers are responsible gain access to a subsidiary account for the minor under the adult user's account with a password to a filtered environment.

6. The method of claim 1, wherein the age is further confirmed by a single number verification method.

7. The method of claim 6, wherein a single number is obtained by applying a formula to the adult's social security number.

8. The method of claim 6, wherein a single number is obtained by applying a formula to the adult's credit card number.

9. The method of claim 1, wherein a prospective adult may be precluded from purchasing the adult access account.

10. The method of claim 1, wherein the access account of an adult purchaser may be canceled at anytime.

11. The method of claim 1, wherein one of the software, information, lists and tools to filter/block access to inappropriate content, activities, individuals and criminal offenders are located on at least one of a server and a computer.

12. A method of verifying an individual's age and identity for a variety of purposes, such as providing an access account, using a system to confirm an individual's age and identity, the steps comprising:
obtaining from the individual a single number that the individual computes by applying a predetermined mathematical formula to the individual's unique identification number, such as the individual's social security number, credit card number, driver's license number or any other unique identification number;
comparing other submitted personal data of the individual to personal data on file for the individual;
retrieving the individual's unique identification number on file;
computing a single number from the retrieved unique identification number;
comparing the computed single number to the individual's computed single number;
verifying the individual's age from the individual's date of birth; and
granting the individual an access account, if the individual is of majority age.

13. The method of claim 12, wherein the single number is computed by adding the nine digits of the individual's social security number and multiplying the sum by the individual's social security number.

14. The method of claim 12, wherein the other submitted personal data is at least one of name, home address, credit card billing address, and date of birth.

15. A method of verifying the age and identity of a minor using a system to limit the minor's use of a parent's access account in a manner that enables the parent to limit the minor's interaction to age appropriate content and individuals while using the parent's access account, the steps comprising:
applying online by an adult for the minor's use of the parent's access account;
completing and signing a minor verification form;
appearing in person with the minor at one of a plurality of approved locations;
submitting in person a completed and signed minor verification form;
validating information in the completed and signed minor verification form, in the presence of the adult and the minor;
validating the adult's and the minor's age and identity, in the presence of the adult and the minor;
notifying the adult of an approval of the minor's use of the parent's access account;
requiring the adult to assume responsibility for access account use by the minor; and
empowering the adult to filter or block access to inappropriate content and individuals.

16. The method of claim 15, wherein the parent's access account is an Internet account or other access account.

17. The method of claim 15, wherein the one of a plurality of approved locations include authorized industries, schools, businesses, organizations, and agencies.

18. The method of claim 15, wherein the minor gains access to an Internet chat room with other minors only.

19. The method of claim 15, wherein the age of the minor is confirmed by a single number verification.

20. A method of creating a “single access account” with an access provider that will be used by at least one age verified and authenticated adult, and possibly minors and others, the steps comprising:
applying online by a prospective user for the “single access account;”
verifying the prospective user as being either an adult or a minor;
ending the application process if the prospective user is not an adult;
continuing the application process if the prospective user is verified as being an adult, wherein the “single access account” and a first user profile is created, and wherein the prospective user is now the “single access account” owner;
selecting a filtering profile for the first user profile;
ending the application process; and
activating filtering based on the selected filtering profile, wherein such filtering is always turned on and can only be turned off with the access provider's permission.

21. The method of claim 20, wherein the “single access account” owner can elect to create additional user profiles for minors and other individuals, wherein an additional user profile is created by the steps of
selecting a prospective additional user;
verifying the prospective additional user as being either an adult or a minor, wherein the additional prospective user is now the second user and a second user profile is created;
activating mandatory filtering for the second user profile if the second user is not verified as being an adult;
selecting, by the “single access account” owner, optional filtering for the second user profile if the second user is not verified as being an adult; and
selecting, by the “single access account” owner, optional filtering for the second user profile if the prospective additional user is verified as being an adult.

22. The method of claim 20 wherein the prospective user is verified as being either an adult or a minor by
completing and signing a verification form;
appearing in person at one of a plurality of approved locations;
submitting in person the completed and signed verification form;
validating information in the verification form in the presence of a preauthorized individual; and
validating the prospective user's age and identity in the presence of the preauthorized individual, whereby it is determined whether the prospective user is an adult or a minor.

23. The method of claim 20 wherein the prospective user is verified as being either an adult or a minor by
obtaining from the prospective user a single number that the prospective user computes by applying a predetermined mathematical formula to the prospective user's unique identification number, such as the prospective user's social security number, credit card number, driver's license number or any other unique identification number;
comparing other submitted personal data of the prospective user to personal data on file for the prospective user;
retrieving the prospective user's unique identification number on file;
computing a single number from the retrieved unique identification number;
comparing the computed single number to the prospective user's computed single number; and
verifying the individual's age from the individual's date of birth, whereby it is determined whether the prospective user is an adult or a minor.

24. The method of claim 21 wherein the additional prospective user is verified as being either an adult or a minor by
completing and signing a verification form;
appearing in person at one of a plurality of approved locations;
submitting in person the completed and signed verification form;
validating information in the verification form in the presence of a preauthorized individual; and
validating the prospective additional user's age and identity in the presence of the preauthorized individual, whereby it is determined whether the prospective user is an adult or a minor.

25. The method of claim 21 wherein the additional prospective user is verified as being either an adult or a minor by
obtaining from the prospective user a single number that the prospective user computes by applying a predetermined mathematical formula to the prospective user's unique identification number, such as the prospective user's social security number, credit card number, driver's license number or any other unique identification number;
comparing other submitted personal data of the prospective user to personal data on file for the prospective user;
retrieving the prospective user's unique identification number on file;
computing a single number from the retrieved unique identification number;
comparing the computed single number to the prospective user's computed single number; and
verifying the individual's age from the individual's date of birth, whereby it is determined whether the prospective user is an adult or a minor.

26. A method of accessing a “single access account” that has at least one user profile associated therewith, the at least one user profile having a predetermined level of access, wherein the “single access account” is maintained by an access provider on a server, the steps comprising:
initiating a user connection to the access provider's server;
entering an account-ID and first password;
authenticating the account-ID and first password;
ending the connection process if the account-ID and first password are not authenticated;
continuing the connection process if the account-ID and first password are validated;
entering a profile-ID and second password;
authenticating the profile-ID and second password as being from amongst the at least one user profile associated with the “single access account”;
ending the connection process if the profile-ID and second password are not validated;
continuing the connection process, if the profile-ID and second password are validated;
applying the predetermined level of access based on the at least one user's profile that is on record in the access provider's database; and
beginning the at least one user's first authenticated and filtered access.

27. The method of claim 26 wherein the “single access account” has at least a second user profile associated therewith.

28. The method of claim 26 wherein predetermined level of access is based on the at least one user's profile and any applicable mandatory filtering imposed by the access provider.

29. A method of filtering Internet content using a “single access account,” wherein the “single access account” is purchased from an access provider, the steps comprising:
determining the age and identity of an adult user, wherein the age and identity of the adult user is determined using an “in person” age and identity verification process;
capturing registration information relating to the adult user in an age-ID database and a profile-ID database that both reside on the access provider's access server;
selecting a first set of filtering directives for the adult user, wherein the adult user selects the first set of filtering directives;
applying a second set of filtering directives, wherein the second set of filtering directives are selected by the access provider, and wherein the first and second set of filtering directives are associated with the profile-ID database; and
implementing RADIUS authentication and proxy based filtering that restricts the Internet access of the adult user based on the first and second set of filtering directives.

30. The method of claim 29 further comprising the steps of
determining the age and identity of at least one additional user, wherein the age and identity of the at least one additional user is determined using an “in person” age and identity verification process;
capturing registration information relating to the at least one additional user in the age-ID database and the profile-ID database;
selecting a first set of filtering directives for the at least one additional user, wherein the adult user selects the first set of filtering directives; and
implementing RADIUS authentication and proxy based filtering that restricts the Internet access of the first additional user based on the first and second set of filtering directives.

31. The method of claim 29 wherein the step of determining the age and identity of the adult user includes a secondary age and identity verification process.

32. The method of claim 30 wherein the step of determining the age and identity of the at least one additional user includes a secondary age and identity verification process.

33. A method of restricting access to an eCommerce website to pre-qualified individuals having an “age-ID” account, the steps comprising:
allowing an individual to attempt to access the eCommerce website;
determining if the individual has an “age-ID” account;
denying access if the individual does not have an “age-ID” account;
confirming the age and identity of the individual if the individual has an “age-ID” account; and
granting access if the age and identity of the individual is verified and if the individual meets the predetermined requirements of the website.

34. The method of claim 33 wherein the step of confirming the age and identity of the individual is performed by referring to the “age-ID” database information and profile-ID database information.
